(19) United States
(12) Patent Application Publication
(10) Pub. No.: US 2012/0099341 A1
(43) Pub. Date: Apr. 26, 2012

(54) BACKLIGHT ASSEMBLY AND DISPLAY APPARATUS HAVING THE SAME

(76) Inventors: Jaejoong KWON, Suwon-si (KR); Hyoung-Joo Kim, Anyang-si (KR); Joo Young Kim, Cheonan-si (KR); Sung-Kyu Shim, Seoul (KR); Seung-Hwa Ha, Cheongju-si (KR); Seul-Gi Kim, Seoul (KR); Young-Min Park, Seoul (KR); Hayoung Lee, Seoul (KR)

(21) Appl. No.: 13/172,763

(22) Filed: Jun. 29, 2011

(30) Foreign Application Priority Data
Oct. 25, 2010 (KR) 10-2010-0104119

(51) Int. Cl. F21V 8/00

(52) U.S. Cl. 362/612; 362/632; 362/631

(57) ABSTRACT

In a backlight assembly and a display apparatus having the backlight assembly, the backlight assembly includes a back cover configured to accommodate and retain a light source mounted on a circuit substrate into a receiving cavity of the back cover. Heat generated by the light source may be effectively transmitted to the back cover, thereby preventing temperature in the backlight assembly from increasing.

### CROSS-REFERENCE TO RELATED APPLICATION

This application relies for priority upon Korean Patent Application No. 10-2010-0104119 filed on Oct. 25, 2010, the contents of which are herein incorporated by reference in its entirety.

### BACKGROUND

1. Field of Disclosure

The subject matter disclosed herein relates to a backlight assembly and a display apparatus having the same. More particularly, the subject matter disclosed herein relates to a backlight assembly having an improved heat-radiation property and a display apparatus having the backlight assembly.

2. Description of the Related Art

A backlight assembly employing a light emitting diode as a light source and a display apparatus having the backlight assembly has been recently developed.

The backlight assembly has various advantages, such as low power consumption, small volume, high brightness, etc., when compared with a backlight assembly having a cold cathode fluorescent lamp as a light source thereof.

However, when heat generated from the light emitting diode is ineffectively radiated the temperature in the backlight assembly increases. As a result, light emitting efficiency of the light emitting diode is deteriorated, and a light guide plate is deformed by the heat causing deterioration in display quality.

### SUMMARY

Exemplary embodiments provide a backlight assembly capable of improving heat-radiation property thereof.

Exemplary embodiments provide a display apparatus having the backlight assembly.

According to the exemplary embodiments, a backlight assembly includes a light source emitting a light, a circuit substrate on which the light source is mounted, a back cover accommodates the light source and the circuit substrate is coupled with an end of the light guide plate. The back cover includes a bottom portion to support the circuit substrate, a cover portion to cover an upper portion of the light source and accommodate the end of the light guide plate between the bottom portion and the cover portion, and a connector portion to connect the bottom portion and the cover portion. At least a portion of the back cover presses at least one of the light source or the circuit substrate.

According to the exemplary embodiments, a display apparatus includes a backlight assembly generating a light and a display panel receiving the light to display an image.

The backlight assembly includes a light source emitting a light, a light guide plate including a plurality of side surfaces receiving the light through at least one side surface of the side surfaces and outputting the light through an upper surface thereof, a circuit substrate on which the light source is mounted, a back cover accommodates the light source and the circuit substrate is coupled with an end of the light guide plate. The back cover includes a bottom portion to support the circuit substrate, a cover portion to cover an upper portion of the light source and accommodate the end of the light guide plate between the bottom portion and the cover portion, and a connector portion to connect the bottom portion and the cover portion. At least a portion of the back cover presses at least one of the light source or the circuit substrate.

According to the above, the backlight assembly may press the light source or the circuit substrate by using at least the portion of the back cover, thereby fixing the circuit substrate to the back cover to allow the circuit substrate to make contact with the back cover.

Accordingly, heat generated by the light source may be effectively transmitted to the back cover, thereby preventing temperature in the backlight assembly from increasing due to the heat generated from the light source.

### BRIEF DESCRIPTION OF THE DRAWINGS

The above and other aspects of the subject matter disclosed herein will become readily apparent by reference to the following detailed description when considered in conjunction with the accompanying drawings wherein:

FIG. 1 is an exploded perspective view showing a backlight assembly according to an exemplary embodiment;

FIG. 2 is a cross-sectional view taken along a line I-I′ of FIG. 1;

FIG. 3 is a cross-sectional view showing a coupling between a back cover and a light guide plate of FIG. 2;

FIG. 4 is a cross-sectional view showing a back cover according to another exemplary embodiment;

FIG. 5 is a cross-sectional view showing a back cover according to another exemplary embodiment;

FIG. 6 is an exploded perspective view showing a backlight assembly according to another exemplary embodiment;

FIG. 7 is a cross-sectional view taken along a line II-II′ of FIG. 6;

FIG. 8 is a cross-sectional view taken along a line III-III′ of FIG. 7;

FIG. 9 is a plan view showing a backlight assembly according to another exemplary embodiment;

FIG. 10 is a perspective view showing a back cover of FIG. 9;

FIG. 11 is a cross-sectional view taken along a line IV-IV′ of FIG. 9;

FIG. 12 is a plan view showing a backlight assembly according to another exemplary embodiment;

FIG. 13 is a partially enlarged perspective view of a portion V of FIG. 12;

FIG. 14 is a cross-sectional view taken along a line VI-VI′ of FIG. 13;

FIG. 15 is a partially enlarged perspective view of a portion V of FIG. 12 according to another exemplary embodiment;

FIG. 16 is a cross-sectional view taken along a line VII-VII′ of FIG. 15;

FIG. 17 is a plan view showing a backlight assembly according to another exemplary embodiment;

FIG. 18 is a cross-sectional view taken along a line VIII-VIII′ of FIG. 17;

FIG. 19 is an exploded perspective view showing a display apparatus employing a backlight assembly shown in FIG. 1; and

FIG. 20 is an exploded perspective view showing a display apparatus employing a backlight assembly shown in FIG. 6.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the claimed subject matter will be explained in detail with reference to the accompanying drawings.

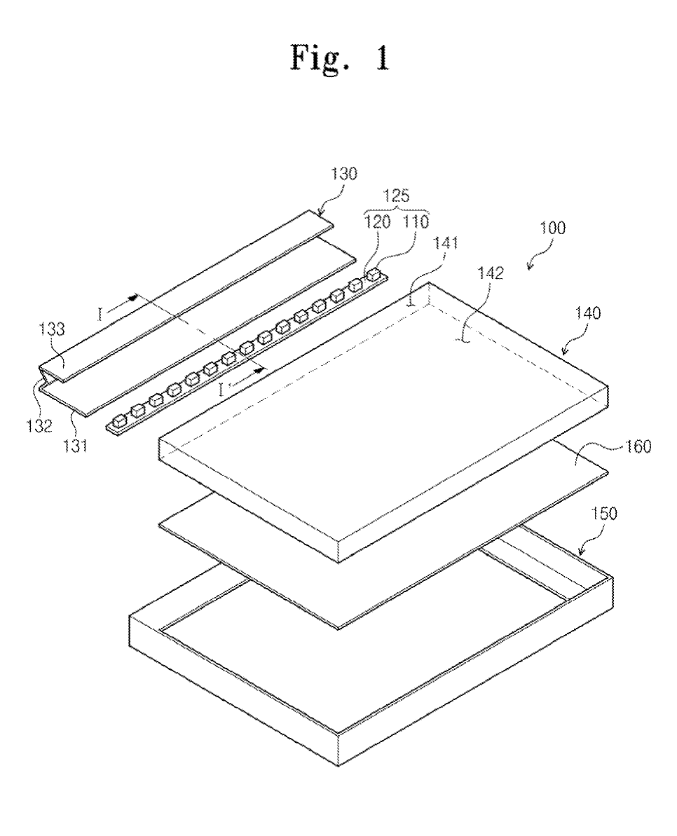

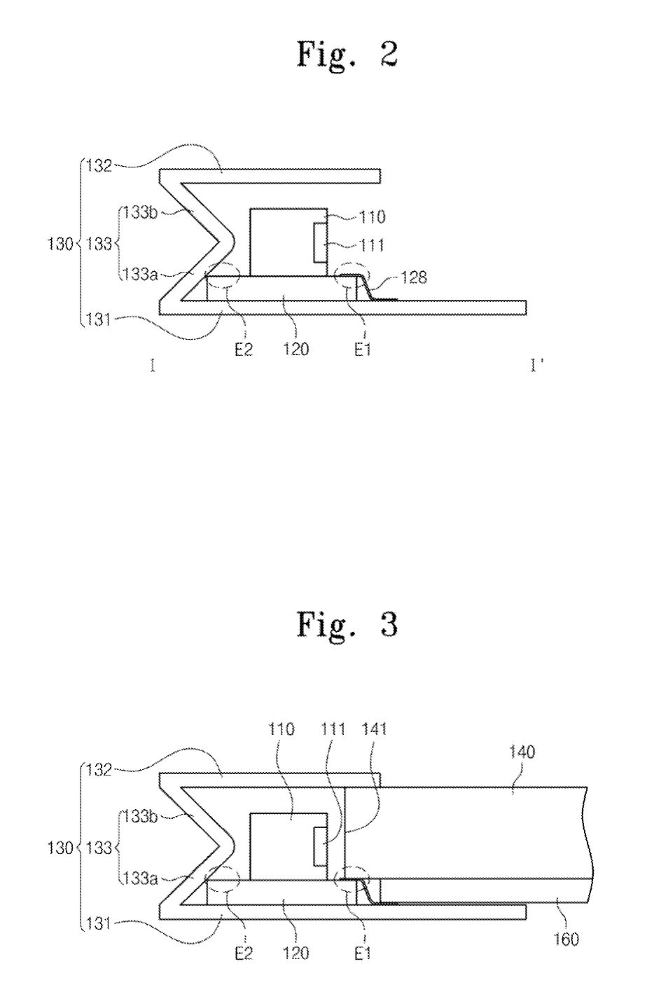

FIG. 1 is an exploded perspective view showing a backlight assembly according to an exemplary embodiment, FIG. 2 is a cross-sectional view taken along a line I-I′ of FIG. 1, and FIG. 3 is a cross-sectional view showing a coupling between a back cover and a light guide plate of FIG. 2.

Referring to FIGS. 1 and 2, a backlight assembly 100 includes a light source 110, a circuit substrate 120, a back cover 130, a light guide plate 140, a receiving container 150, and a reflection sheet 160.

The light source 110 includes a plurality of light emitting diodes (LEDs) that receives a driving voltage to emit light. The LEDs 110 are mounted on the circuit substrate 120 to receive the driving voltage through the circuit substrate 120. Although not shown in FIGS. 1 to 3, the circuit substrate 120 is electrically connected to a power supply (not shown) to receive the driving voltage from the power supply and apply the driving voltage to the LEDs 110.

The circuit substrate 120 has a bar-like shape extending in a direction and the LEDs 110, which are mounted on the circuit substrate 120, are arranged in a line shape along the circuit substrate 120. The circuit substrate 120 may be a flexible printed circuit (FPC), for example, double-sided flexible printed circuit, or a metal printed circuit board (MPCB). Hereinafter, for the convenience of explanation, a structure in which the LEDs 110 are mounted on the circuit substrate 120 is referred to as an LED or light source bar 125.

The back cover 130 is bent to surround the LED bar 125 and a side portion of the back cover 130 is opened. The back cover 130 includes a reflective material such as aluminum to reflect the light emitted from the LEDs 110 to the opened side portion thereof.

The back cover 130 includes a bottom portion 131, a cover portion 132 parallel to the bottom portion 131, and a connector portion 133 connecting the bottom portion 131 and the cover portion 132.

As shown in FIG. 2, the circuit substrate 120 is mounted on the bottom portion 131 and the cover portion 132 faces the bottom portion 131 to provide a space in which the circuit substrate 120 and the LEDs 110 are accommodated. The bottom portion 131 and the cover portion 132 are connected with each other by the connector portion 133.

The backlight assembly 100 further includes a fixing tape 128 to fix the circuit substrate 120 mounted on the bottom portion 131 to the bottom portion 131. The fixing tape 128 is attached to a first upper end surface E1 of the circuit substrate 120 and an upper surface of the bottom portion 131 to fix a first end of the circuit substrate 120 to the bottom portion 131. In the present exemplary embodiment, the fixing tape 128 may have a white color.

The connector portion 133 of the back cover 130 includes a first inclined portion 133a that is inclined to a second upper end surface E2 opposite to the first upper end surface E1 of the circuit substrate 120 to press the circuit substrate 120. The first inclined portion 133a presses a second end of the circuit substrate 120, thereby fixing the second end of the circuit substrate 120 to the bottom portion 131.

As described above, since the first end of the circuit substrate 120 is fixed to the bottom portion 131 by the fixing tape 128 and the second end of the circuit substrate 120 is pressed by the first inclined portion 133a, the circuit substrate 120 may be prevented from being separated from the bottom portion 131.

The connector portion 133 further includes a second inclined portion 133b to connect the first inclined portion 133a to the cover portion 132. Thus, the connector portion 133 may have a V-shape.

Referring again to FIG. 1, the light guide plate 140 has a rectangular plate-like shape and includes a transparent material that refracts the light. Accordingly, the light guide plate 140 receives the light emitted from the LEDs 110 through at least one lateral surface 141 (hereinafter, referred to as incident surface) adjacent to the LED bar 125 and changes a traveling path of the incident light to output the light through an upper surface 142 thereof. For instance, in the case that the backlight assembly 100 is employed in a liquid crystal display including a liquid crystal display panel (not shown) as a light source, the light guide plate 140 may guide the light provided from the LEDs 110 to the liquid crystal display panel.

As shown in FIG. 3, each LED 110 includes a light emitting surface 111 to emit the light. An end of the light guide plate 140 is mounted on the first upper end surface E1 of the circuit substrate 120 and inserted into the back cover 130 in order to allow the incident surface 141 to face the light emitting surface 111. However, in the case that the light guide plate 140 is insufficiently inserted into the back cover 130 or the light guide plate 140 is bent, weight larger than weight applied to the second end of the circuit substrate 120 may be applied to the first end of the circuit substrate 120, and thus the second end of the circuit substrate 120 may be separated from the bottom portion 131. In this case, since the first inclined portion 133a of the connector portion 133 presses the second end of the circuit substrate 120, the second end of the circuit substrate 120 may be prevented from being separated from the bottom portion 131.

As described above, when the circuit substrate 120 makes contact with the bottom portion 131 to be adhered closely to the bottom portion 131, the heat generated by the LEDs 110 may be effectively transmitted to the back cover 130 through the circuit substrate 120. Accordingly, the LEDs 110 may have improved heat-radiation property.

Referring to FIG. 1 again, the receiving container 150 includes a sidewall 151 having a rectangular ring shape and a bottom 152 extended from a lower portion of the sidewall 151. The receiving container 150 provides a receiving space defined by the sidewall 151 and the bottom 152, and the back cover 130 and the light guide plate 140 are accommodated in the receiving space of the receiving container 150.

The reflection sheet 160 is disposed below the light guide plate 140 and reflects the light leaked from the light guide plate 140 to provide the light to the light guide plate 140 again. Thus, the loss of the light in the light guide plate 140 may be reduced. The reflection sheet 160 may be formed of a material that reflects the light, such as polyethylene terephthalate (PET), aluminum, etc.

Although not shown in FIGS. 1 to 3, optical sheets (not shown) may be provided on the light guide plate 140. The optical sheets may include at least one prism sheet that collects the light exiting from the light guide plate 140 to improve front brightness and at least one diffusion sheet to diffuse the light.

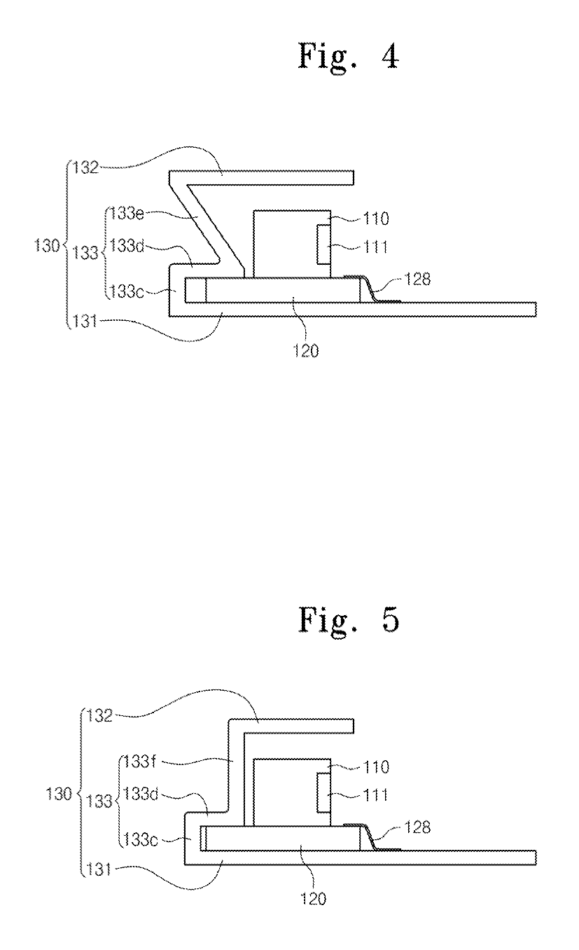

FIG. 4 is a cross-sectional view showing a back cover according to another exemplary embodiment.

Referring to FIG. 4, a back cover 135 includes a bottom portion 131, a cover portion 132 parallel to the bottom portion 131, and a connector portion 133 connecting the bottom portion 131 and the cover portion 132.

The circuit substrate 120 is mounted on the bottom portion 131 and the cover portion 132 faces the bottom portion 131 to provide a receiving space or cavity in which the circuit substrate 120 and the LEDs 110 are accommodated. The bottom portion 131 and the cover portion 132 are connected with each other by the connector portion 133.

The backlight assembly 100 further includes a fixing tape 128 to fix the circuit substrate 120, which is mounted on the bottom portion 131, to the bottom portion 131. In detail, the fixing tape 128 is attached to a first upper end surface E1 of the circuit substrate 120 and an upper surface of the bottom portion 131 to fix a first end of the circuit substrate 120 to the bottom portion 131.

The connector portion 133 includes a first vertical portion 133c that is vertically extended from the bottom portion 131, a flat portion 133d extended from the first vertical portion 133c to be parallel to the upper surface of the circuit substrate 120, and an inclined portion 133e connecting the flat portion 133d to the cover portion 132.

The flat portion 133d makes direct contact with a second upper end surface E2 of the circuit substrate 120 to allow the second end of the circuit substrate 120 to be adhered closely to the bottom portion 131.

As described above, the first end of the circuit substrate 120 is fixed to the bottom portion 131 by the fixing tape 128 and the second end of the circuit substrate 120 is adhered to the bottom portion 131 by the flat portion 133d, thereby preventing the circuit substrate 120 from being separated from the bottom portion 131.

FIG. 5 is a cross-sectional view showing a back cover according to another exemplary embodiment.

Referring to FIG. 5, a back cover 137 has the same structure and function as the back cover 135 shown in FIG. 4 except for the connector portion 133.

In particular, the connector portion 133 includes a first vertical portion 133c vertically extended from the bottom portion 131, a flat portion 133d extended from the first vertical portion 133c to be parallel to the upper surface of the circuit substrate 120, and a second vertical portion 133f connecting the flat portion 133d to the cover portion 132.

In addition to those embodiments disclosed above, the connector portion 133 may have various structures to press or adhere the circuit substrate 120 to the bottom portion 131.

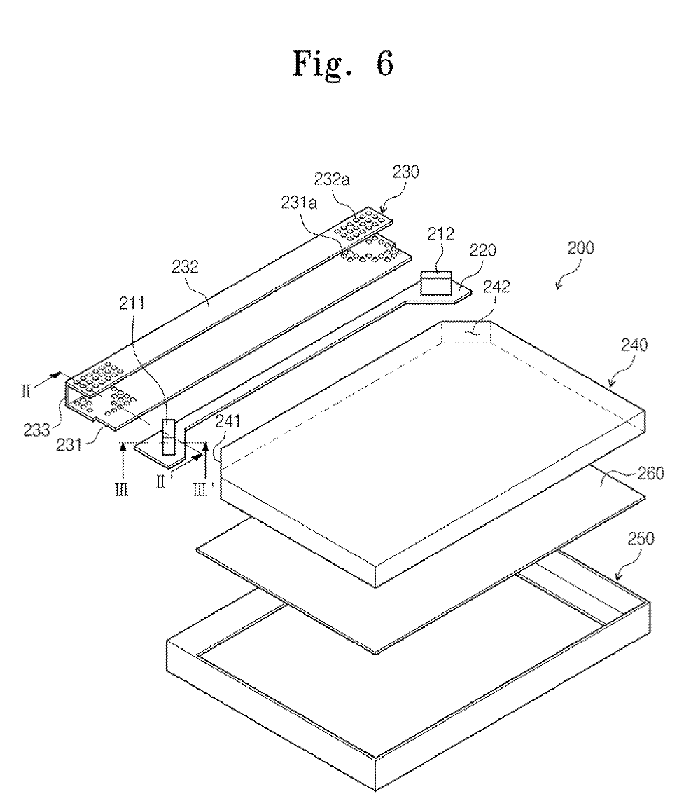

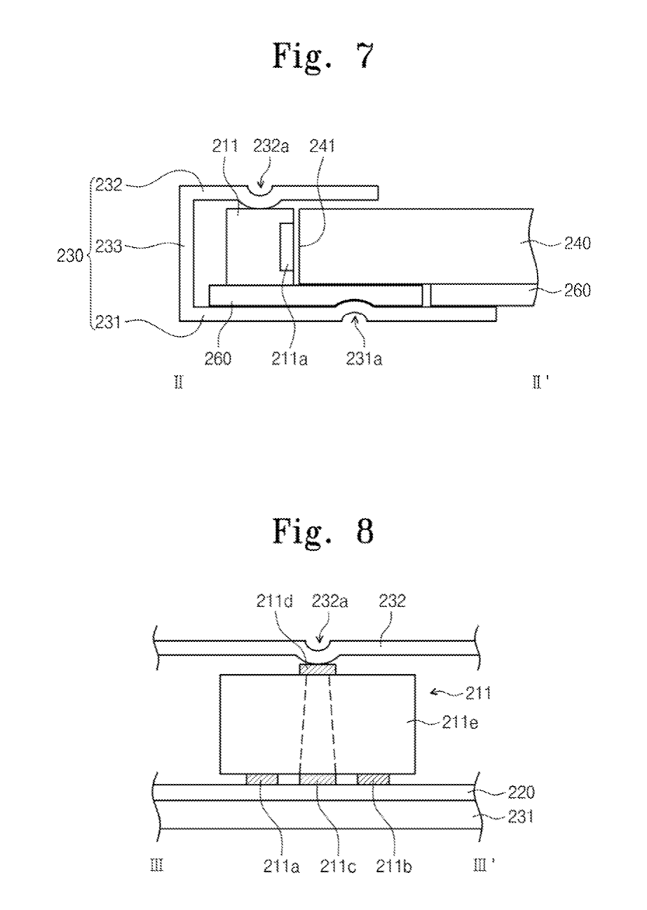

FIG. 6 is an exploded perspective view showing a backlight assembly according to another exemplary embodiment, and FIG. 7 is a cross-sectional view taken along a line II-II′ of FIG. 6.

Referring to FIGS. 6 and 7, a backlight assembly 200 includes light sources 211 and 212, a circuit substrate 220, a back cover 230, a light guide plate 240, a receiving container 250, and a reflection sheet 260.

The light guide plate 240 includes first and second corner portions that are chamfered. Thus, first and second incident surfaces 241 and 242 defined by chamfering the first and second corner portions of the light guide plate 240 are provided at the first and second corner portions, respectively. The light guide sources include a first LED 211 positioned adjacent to the first incident surface 241 and a second LED 212 positioned adjacent to the second incident surface 242.

The circuit substrate 220 has a bar-like shape extended in one direction and the first and second LEDs 211 and 212 are mounted on opposite ends of the circuit substrate 220, respectively. The ends of the circuit substrate 220 may have a width wider than a width of a center portion disposed between the ends. In addition, the circuit substrate 220 may be a flexible printed circuit (FPC), for example, double-sided flexible printed circuit, or a metal printed circuit board (MPCB).

The back cover 230 is bent to surround an end of the light guide plate 240 and a side portion of the back cover 230 is opened to accommodate the end of the light guide plate 240. The back cover 230 includes a reflective material such as aluminum (Al) to reflect the light emitted from the first and second LEDs 211 and 212 to the light guide plate 240 through the opened side portion thereof.

The back cover 230 includes a bottom portion 231, a cover portion 232 parallel to the bottom portion 231, and a connector portion 233 connecting the bottom portion 231 and the cover portion 232.

As shown in FIG. 7, the circuit substrate 220 is mounted on the bottom portion 231, and the connector portion 233 connects and spaces apart the bottom portion 231 and the cover portion 232 to provide a receiving space or cavity between the bottom portion 231 and the cover portion 232 in which the circuit substrate 220, the first LED 211, and the second LED 212 are accommodated.

The cover portion 232 includes a plurality of first protrusions 232a protruded to the receiving space of the back cover 230 and disposed at both ends thereof. As shown in FIG. 7, when the circuit substrate 220 and the first and second LEDs 211 and 212 are accommodated in the receiving space of the back cover 230, at least one protrusion of the first protrusions 232a protruded from one end of the back cover 230 makes contact with the first LED 211. Accordingly, the heat generated by the first LED 211 may be transmitted to the back cover 230 through the first protrusions 232a. As a result, the heat-radiation property of the backlight assembly 200 may be improved.

In addition, since the first protrusions 232a presses the first LED 211, the circuit substrate 220 accommodated in the receiving container of the back cover 230 may be fixed to the bottom portion 231 while making contact the circuit substrate 220 with the bottom portion 231.

Similar to the first LED 211, the second LED 212 may make contact with the first protrusions 232a at the opposite end of the circuit substrate 220.

The first LED 211 faces a first incident surface 241 of the light guide plate 240 and includes a light emitting surface 211a through which the light is emitted. The light emitting surface 211a may be substantially parallel to the first incident surface 241 and vertical to the upper surface of the circuit substrate 220.

The circuit substrate 220 may be mounted on the bottom portion 231 of the back cover 230 and the first corner portion of the light guide plate 240 may be mounted on the one end of the circuit substrate 220. Accordingly, the first corner portion of the light guide plate 240 may be disposed between the circuit substrate 220 and the cover portion 232 of the back cover 230.

The back cover 230 includes a plurality of second protrusions 231 a protruded from the bottom portion 231 to the circuit substrate 220. Since the second protrusions 231a are formed on the bottom portion 231, the surface area of the bottom portion 231 may be increased, thereby effectively radiating the heat transmitted to the circuit substrate 220 through the bottom portion 231. Therefore, the heat-radiation property of the backlight assembly 200 may be improved.

FIG. 8 is a cross-sectional view taken along a line III-III′ of FIG. 7.

Referring to FIG. 8, the first LED 211 includes a resin layer 211e, first and second terminals 211a and 211b provided at a lower portion of the resin layer 211e to receive a driving voltage, and a third terminal 211c provided between the first and second terminals 211a and 211b to radiate the heat.

The first and second terminals 211a and 211b are electrically connected to the circuit substrate 220 to receive the driving voltage from the circuit substrate 220. Meanwhile, the third terminal 211c makes contact with the circuit substrate 220 to transmit the heat generated by the first LED 211 to the circuit substrate 220. The third terminal 211c may include a material, such as copper (Cu), having higher heat conductivity than that of the resin layer 211e and the first and second terminals 211a and 211b.

In addition, the first LED 211 is connected to the third terminal 211c inside the resin layer 211e and further includes a heat radiation bump 211d disposed on the resin layer 211e. The heat radiation bump 211d may include the same material as the third terminal 211c, for example, copper (Cu).

The heat radiation bump 211d may be connected with the cover portion 232 of the back cover 230 and at least one of the first protrusions 232a provided at the cover portion 232. Accordingly, the heat generated by the first LED 211 may be transmitted to the back cover 230 through the heat radiation bump 211d, thereby improving the heat-radiation property of the backlight assembly 200.

Although not shown in FIG. 8, the second LED 212 has the structure similar to that of the first LED 211, and thus detailed description of the second LED 212 will be omitted.

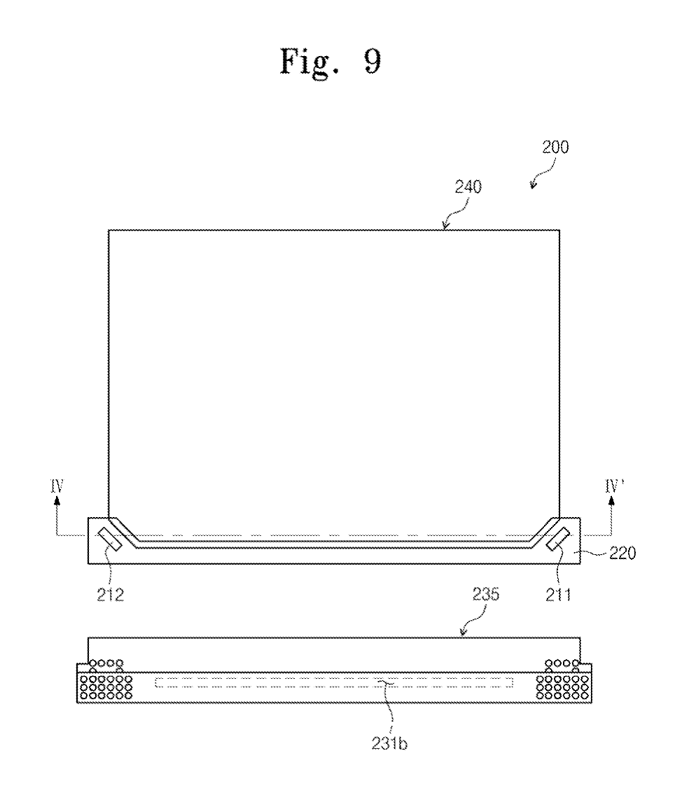

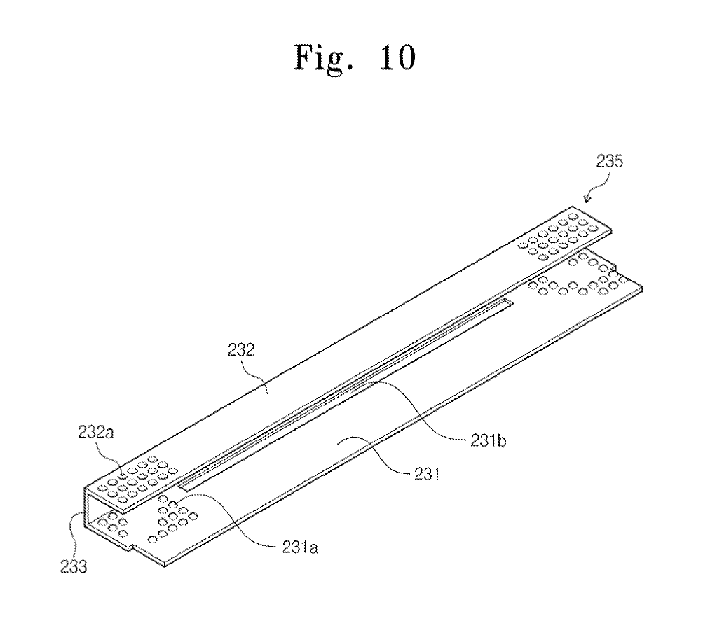

FIG. 9 is a plan view showing a backlight assembly according to another exemplary embodiment, and FIG. 10 is a perspective view showing a back cover of FIG. 9. In FIG. 9, the same reference numerals denote the same elements in FIG. 6, and thus detailed description of the same elements will be omitted.

Referring to FIGS. 9 and 10, a backlight assembly 200further includes a double-sided tape 235 to fix the circuit substrate 220 to the bottom portion 231 of the back cover 230.

Particularly, the bottom portion 231 is provided with a receiving recess 23 lb provided between the both ends of the bottom portion 231 to accommodate the double-sided tape 235. The receiving recess 231b is formed by recessing the upper surface of the bottom portion 231.

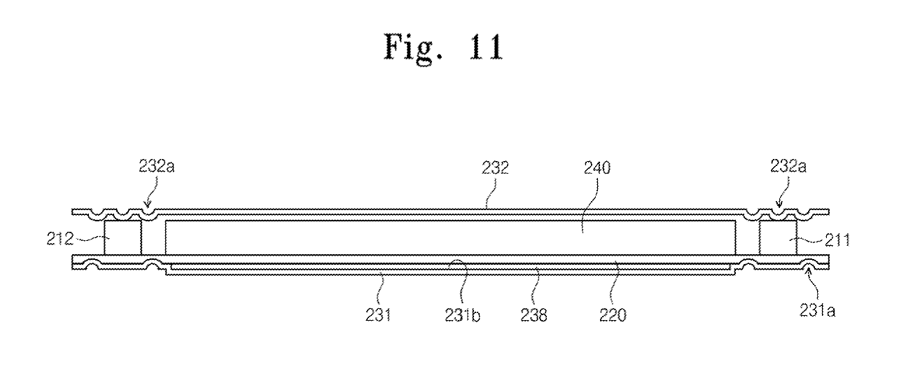

FIG. 11 is a cross-sectional view taken along a line IV-IV′ of FIG. 9.

Referring to FIG. 11, the receiving recess 231b is provided at the portion of the bottom portion 231 corresponding to the portion between the first and second LEDs 211 and 212. When the double-sided tape 235 is accommodated in the receiving recess 231b, a lower surface of the double-sided tape 235 is attached to the bottom portion 231.

Then, when the circuit substrate 220 is mounted on the bottom portion 231, an upper surface of the double-sided tape 235 is attached to the circuit substrate 220. Thus, the circuit substrate 220 may be fixed to the bottom portion 231 by the double-sided tape 235.

Meanwhile, both ends of the circuit substrate 220, to which the double-sided tape 235 is not attached, may be fixed to the bottom portion 231 by the first protrusions 232a pressing the upper surface of the first and second LEDs 211 and 212.

Accordingly, the heat-radiation property of the backlight assembly 200 may be improved and the movement of the circuit substrate 220 may be prevented.

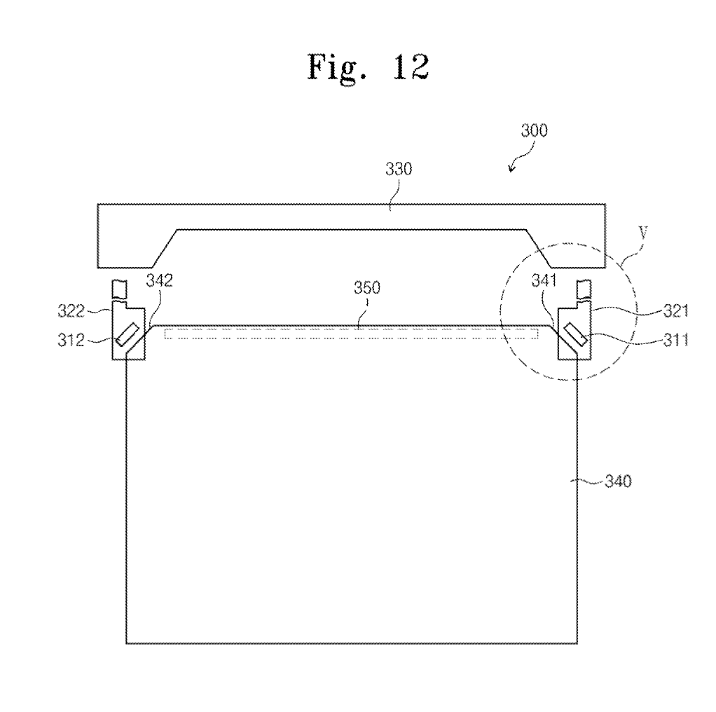

FIG. 12 is a plan view showing a backlight assembly according to another exemplary embodiment.

Referring to FIG. 12, a backlight assembly 300 includes first and second LEDs 311 and 312, first and second circuit substrates 321 and 322, a back cover 330, and a light guide plate 340.

The light guide plate 340 includes first and second corner portions that are chamfered. Thus, first and second incident surfaces 341 and 342 defined by chamfering the first and second corner portions of the light guide plate 340 are provided at the first and second corner portions, respectively. The first and second LEDs 311 and 312 are positioned adjacent to the first and second incident surfaces 341 and 342, respectively.

The first and second LEDs 311 and 312 are mounted on the first and second circuit substrates 321 and 322, respectively. The first and second circuit substrates 321 and 322 may be positioned at the first and second corner portions. In the present exemplary embodiment, the first and second circuit substrates 321 and 322 may be a flexible printed circuit (FPC), for example, double-sided flexible printed circuit, or a metal printed circuit board (MPCB).

The back cover 330 is bent to surround an end of the light guide plate 340 and a side portion of the back cover 330 is opened to accommodate the end of the light guide plate 340. The back cover 330 includes a reflective material, such as aluminum (Al), to reflect the light emitted from the first and second LEDs 311 and 312 to the light guide plate 340 through the opened side portion thereof.

The backlight assembly 300 includes a double-sided tape 350 to fix the light guide plate 340 to the back cover 330 between the first and second incident surfaces 341 and 342.

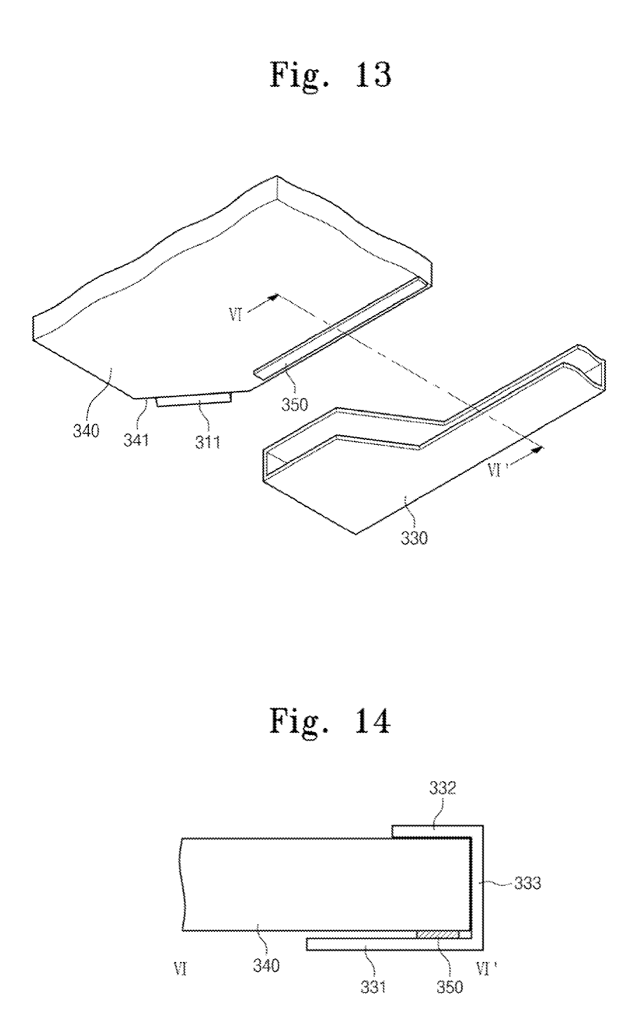

FIG. 13 is a partially enlarged perspective view of a portion V of FIG. 12, and FIG. 14 is a cross-sectional view taken along a line VI-VI′ of FIG. 13.

Referring to FIGS. 13 and 14, the back cover 330 includes a bottom portion 331, a cover portion 332 parallel to the bottom portion 331, and a connector portion 333 connecting the bottom portion 331 and the cover portion 332.

The first and second circuit substrates 321 and 322 are mounted on the both ends of the bottom portion 331, respectively, and the cover portion 332 faces the bottom portion 331 to provide a space in which the one end of the light guide plate 340 is accommodated. The bottom portion 331 and the cover portion 332 are connected with each other by the connector portion 333.

The double-sided tape 350 is disposed between the bottom portion 331 of the back cover 330 and the light guide plate 340 to correspond to the portion between the first and second LEDs 311 and 312. Accordingly, the double-sided tape 350 may fix the light guide plate 340 to the back cover 330.

In detail, although the light guide plate 340 is expanded and contracted due to variation in ambient temperature, the double-sided tape 350 may prevent the one end of the light guide plate 340 from being separated from the back cover 330 or the first and second incident surfaces 341 and 342 of the light guide plate 340 from being spaced apart from the first and second LEDs 311 and 312.

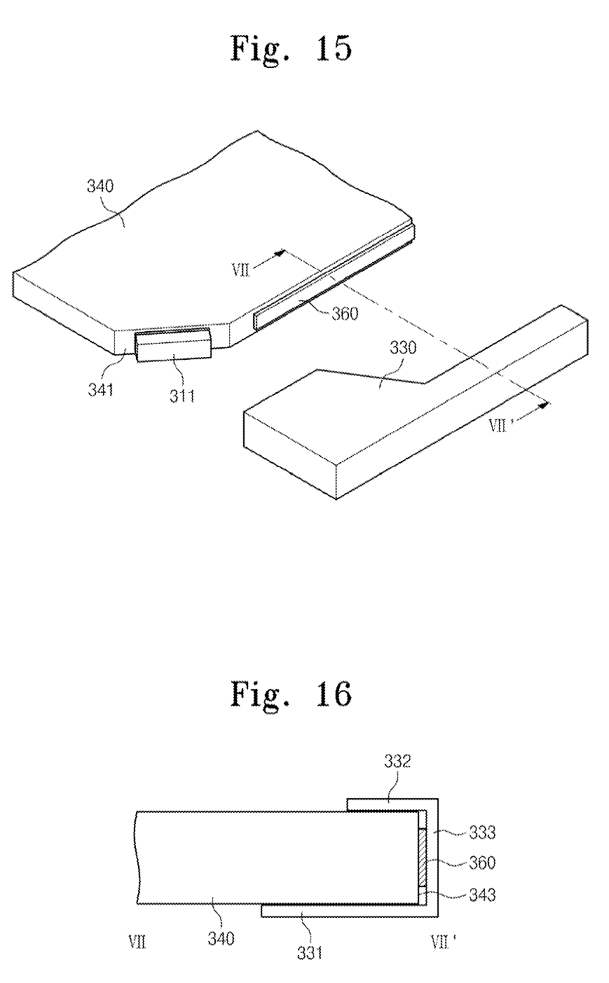

FIG. 15 is a partially enlarged perspective view of a portion V of FIG. 12 according to another exemplary embodiment, and FIG. 16 is a cross-sectional view taken along a line VII-VII′ of FIG. 15. In FIGS. 15 and 16, the same reference numerals denote the same elements in FIGS. 13 and 14, and thus detailed description of the same elements will be omitted.

Referring to FIGS. 15 and 16, a backlight assembly 305 may have the structure similar to that of the backlight assembly 300 shown in FIG. 13 except for that the double-sided tape 360 is attached to a lateral surface of the light guide plate 340.

In particular, the double-sided tape 360 is attached to the lateral surface disposed between the first and second incident surfaces 341 and 342 of the light guide plate 340. Thus, the double-sided tape 360 is disposed between the lateral surface 343 of the light guide plate 340 and the connector portion 333 of the back cover 330, to thereby fix the lateral surface 343 of the light guide plate 340 to the connector portion 333 of the back cover 330.

Hence, the one end of the light guide plate 340 may be prevented from being separated from the back cover 330, and the first and second incident surfaces 341 and 342 of the light guide plate 340 may be prevented from being spaced apart from the first and second LEDs 311 and 312, respectively.

Although not shown in FIGS. 15 and 16, the backlight assembly 305 may further include a receiving container and a reflection sheet, which have structures similar to those of the receiving container 250 and the reflection sheet 260 shown in FIG. 6.

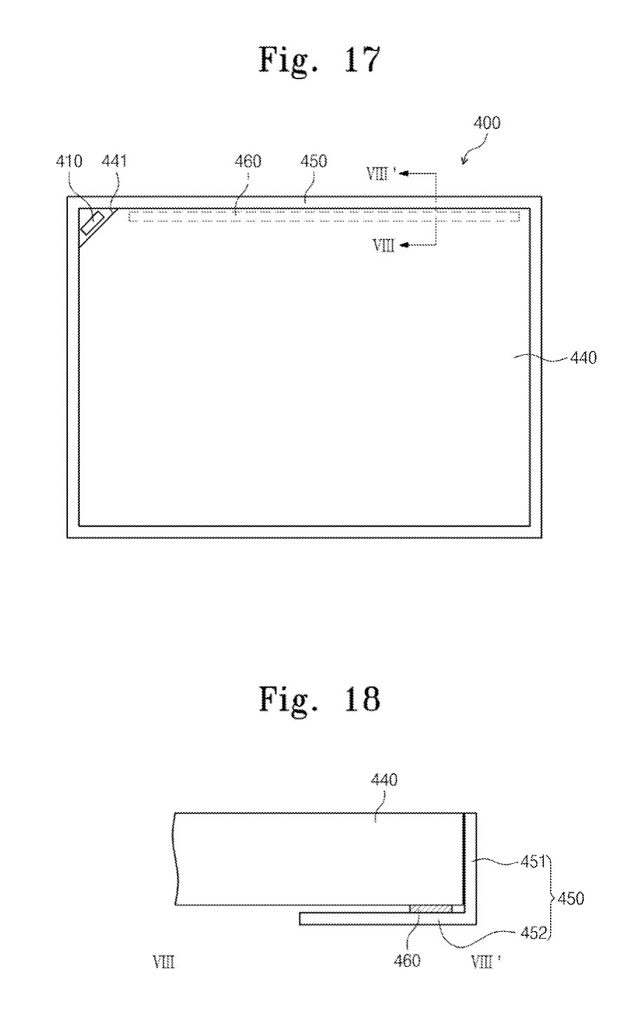

FIG. 17 is a plan view showing a backlight assembly according to another exemplary embodiment, and FIG. 18 is a cross-sectional view taken along a line VIII-VIII′ of FIG. 17.

Referring to FIGS. 17 and 18, a backlight assembly 400 includes a first LED 410, a light guide plate 440, a receiving container 450, and a double-sided tape 460.

The light guide plate 440 includes one corner portion that is chamfered, and an incident surface 441 defined by chamfering the light guide plate 440 is provided at the corner portion. The first LED 410 is positioned adjacent to the incident surface 441.

The light guide plate 440 and the first LED 410 are accommodated in the receiving container 450. In more detail, the receiving container 450 includes a sidewall 451 and a bottom 452 extended from the sidewall 451 to define a receiving space. Accordingly, the light guide plate 440 and the first LED 410 are accommodated in the receiving space of the receiving container 450.

The double-sided tape 460 is disposed between the light guide plate 440 and the bottom 452. Thus, the double-sided tape 460 may fix the one end of the light guide plate 440 to the bottom of the receiving container 450.

As a result, the one end of the light guide plate 440 may be prevented from being separated from the receiving container 450 and the incident surface 441 of the light guide plate 440 may be prevented from being spaced apart from the first LED 411.

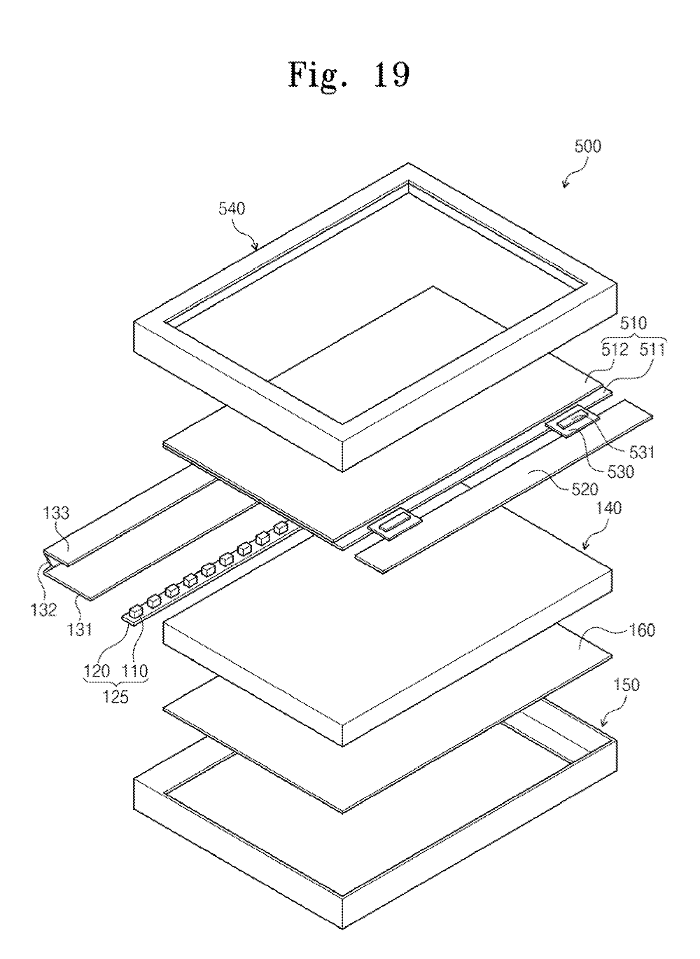

FIG. 19 is an exploded perspective view showing a display apparatus employing a backlight assembly shown in FIG. 1.

Referring to FIG. 19, a display apparatus 500 includes a display panel 510 displaying an image, a backlight assembly 100 disposed at a rear of the display panel 510 to generate light and provide the light to the display panel 510, and a top chassis 540 fixing the display panel 510 to the backlight assembly 100.

In the present exemplary embodiment, the backlight assembly 100 shown in FIG. 19 has the same structure as the backlight assembly 100 shown in FIG. 1, and thus detailed description of the backlight assembly 100 will be omitted.

The display panel 510 includes an array substrate 511 in which a plurality of pixels is arranged, an opposite substrate 512 facing the array substrate 511, and a liquid crystal layer (not shown) disposed between the array substrate 511 and the opposite substrate 512.

In addition, gate lines (not shown) extended in a row direction and data lines (not shown) extended in a column direction are arranged on the array substrate 511. Pixel areas are defined on the array substrate 511 in a matrix form by the gate lines and the data lines, and pixels are arranged in the pixel areas, respectively.

Each pixel includes a thin film transistor and a pixel electrode. The thin film transistor includes a gate electrode connected to a corresponding gate line of the gate lines, a source electrode connected to a corresponding data line of the data lines, and a drain electrode connected to the pixel electrode.

The opposite substrate 512 includes RGB color pixels respectively corresponding to the pixels and a common electrode (not shown) disposed on the RGB color pixels to face the pixel electrode. The liquid crystal layer includes liquid crystal molecules that are arranged by an electric field formed between the pixel electrode and the common electrode, thereby controlling transmittance of the light provided from the backlight assembly 100.

The display apparatus 500 includes a driving chip 531 applying a driving signal to the display panel 510, a tape carrier package 530 on which the driving chip 531 is mounted, and a printed circuit board 520 electrically connected to the display panel 510.

Meanwhile, the driving chip 531 generates the driving signal in response to external signal to drive the display panel 510. The external signal is provided from the printed circuit board 520 and may include various signals, such as image signal, various control signals, driving voltage, etc.

The display panel 510 needs a gate signal and a data signal to display the image. The driving chip 531 includes a data driver (not shown) to convert the image signal into the data signal and apply the data signal to the display panel 510. As an example, a gate driver (not shown) that generates the gate signal may be directly formed on the array substrate 511, but it should not be limited thereto or thereby. That is, the gate driver may be formed in a chip, and thus the gate driver may be mounted on the array substrate 511 or the tape carrier package 530.

The display panel 510 is received in the receiving container 150. The top chassis 540 is coupled with the receiving container 150 to press the display panel 510 to the receiving container 150, thereby preventing the display panel 510 from being separated from the receiving container 150.

As shown in FIG. 19, when the connector portion 133 of the back cover 130 includes the inclined portion used to press the circuit substrate 120, the circuit substrate 120 accommodated in the back cover 130 may make contact with and be fixed to the bottom portion 131. Accordingly, the heat generated by the LED 110 may be effectively transmitted to the back cover 130 through the circuit substrate 120. As a result, the heat-radiation property of the backlight assembly 100 may be improved.

FIG. 19 is an exploded perspective view showing a display apparatus employing a backlight assembly shown in FIG. 1.

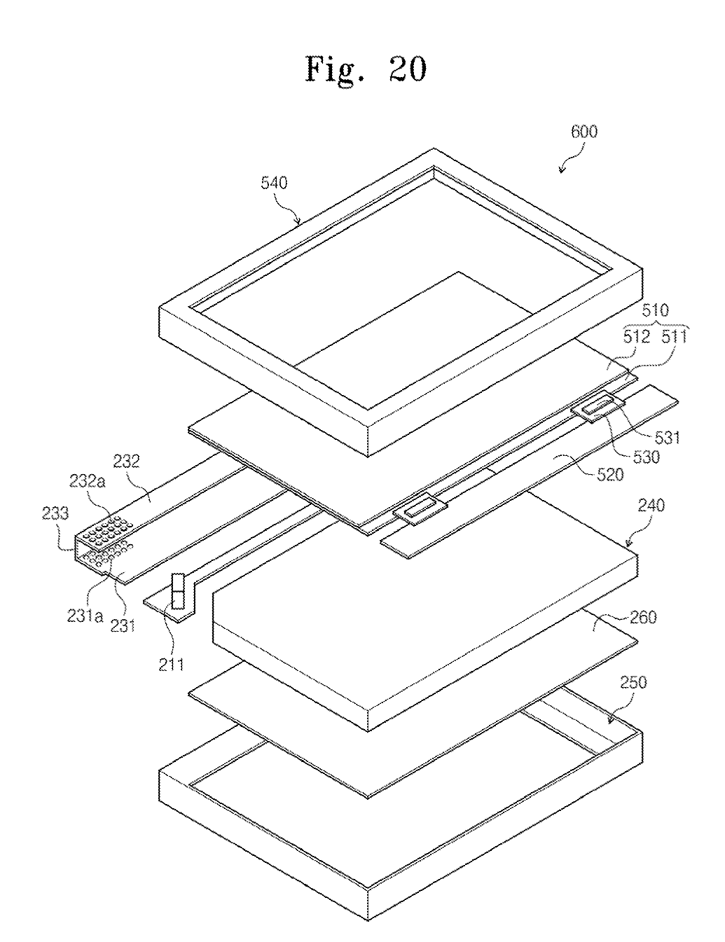

Referring to FIG. 20, a display apparatus 600 has the structure similar to that of the display apparatus 500 shown in FIG. 19 except for that it employs the backlight assembly 200 shown in FIG. 6.

The backlight assembly 200 shown in FIG. 20 has the same structure as the backlight assembly 200 shown in FIG. 6, and thus detailed description of the backlight assembly 200 will be omitted.

As shown in FIG. 20, the bottom portion 231 and the cover portion 232 of the back cover 230 include the first and second protrusions 231a and 232a, respectively, so that the circuit substrate 220 may make contact with and be fixed to the back cover 230. Accordingly, the heat generated from the first and second LEDs 211 and 212 may be effectively transmitted to the back cover 230 through the circuit substrate 220. As a result, the heat-radiation property of the backlight assembly 200 may be improved.

Although the exemplary embodiments have been described, it is understood that the claimed subject matter should not be limited to these exemplary embodiments but various changes and modifications can be made by one ordinary skilled in the art within the spirit and scope hereinafter claimed.

What is claimed is:

1. A backlight assembly comprising:
a light source emitting a light;
a light guide plate including a plurality of side surfaces, the light guide plate receiving the light through at least one side surface of the side surfaces and outputting the light through an upper surface thereof;
a circuit substrate on which the light source is mounted; and
a back cover including a bottom portion to support the circuit substrate, a cover portion to cover an upper portion of the light source and accommodate an end of the light guide plate between the bottom portion and the cover portion, and a connector portion to connect the bottom portion and the cover portion, wherein at least a portion of the back cover presses at least one of the light source or the circuit substrate.

2. The backlight assembly of claim 1, wherein the circuit substrate comprises a first upper end surface extended to the light guide plate with reference to the light source and a second upper end surface extended to an opposite direction to the first upper end surface with reference to the light source.

3. The backlight assembly of claim 2, wherein the connector portion comprises an inclined portion inclined to the second upper end surface of the circuit substrate to press the circuit substrate.

4. The backlight assembly of claim 2, wherein the connector portion comprises a flat portion that is bent to the circuit substrate and extended parallel to the second upper end surface of the circuit substrate to make contact with the second upper end surface of the circuit substrate.

5. The backlight assembly of claim 2, further comprising a fixing tape attached to the first upper end surface and the bottom portion to fix the circuit substrate to the bottom portion.

6. The backlight assembly of claim 1, wherein the light source comprises a plurality of light emitting diodes that emits the light through a light emitting surface facing the one side surface of the light guide plate, and the light emitting diodes are arranged along the one side surface of the light guide plate.

7. The backlight assembly of claim 1, wherein the cover portion comprises a plurality of first protrusions protruded to the light source to press the light source.

8. The backlight assembly of claim 7, wherein the light source comprises a heat radiation bump that makes contact with the cover portion.

9. The backlight assembly of claim 7, wherein the bottom portion comprises a plurality of second protrusions protruded to the circuit substrate.

10. The backlight assembly of claim 1, wherein the light guide plate comprises at least two corner portions that are chamfered, and the light source comprises a first light emitting diode and a second light emitting diode to provide the light to a first incident surface and a second incident surface that are defined by chamfering the light guide plate.

11. The backlight assembly of claim 10, further comprising a first fixing member to fix the circuit substrate to the bottom portion of the back cover, wherein the bottom portion is provided with a receiving recess disposed between the first light emitting diode and the second light emitting diode to receive the first fixing member.

12. The backlight assembly of claim 11, wherein the first fixing member is a double-sided tape.

13. The backlight assembly of claim 10, further comprising a third fixing member disposed between the light guide plate and the bottom portion to correspond to an area between the first and second incident surfaces, wherein the third fixing member fixes the light guide plate to the back cover.

14. The backlight assembly of claim 10, further comprising a second fixing member disposed between the connector portion of the back cover and a lateral surface connecting the first incident surface and the second incident surface of the light guide plate, wherein the second fixing member fixes the light guide plate to the back cover.

15. The backlight assembly of claim 1, further comprising:
a reflection sheet disposed below the light guide plate to reflect the light leaked from the light guide plate; and
a receiving container accommodating the back cover, the light guide plate, and the reflection sheet.

16. A display apparatus comprising:
a backlight assembly generating a light; and
a display panel receiving the light to display an image, the backlight assembly comprising:
a light source emitting a light;
a light guide plate including a plurality of side surfaces, the light guide plate receiving the light through at least one side surface of the side surfaces and outputting the light through an upper surface thereof;
a circuit substrate on which the light source is mounted; and
a back cover including a bottom portion to support the circuit substrate, a cover portion to cover an upper portion of the light source and accommodate an end of the light guide plate between the bottom portion and the cover portion, and a connector portion to connect the bottom portion and the cover portion, wherein at least a portion of the back cover presses at least one of the light source or the circuit substrate.

17. The display apparatus of claim 16, wherein the circuit substrate comprises a first upper end surface extended to the light guide plate with reference to the light source and a second upper end surface extended to an opposite direction to the first upper end surface with reference to the light source, and the connector portion comprises an inclined portion inclined to the second upper end surface of the circuit substrate to press the circuit substrate.

18. The display apparatus of claim 17, further comprising a fixing tape attached to the first upper end surface and the bottom portion to fix the circuit substrate to the bottom portion
